(19) United States
(12) Patent Application Publication
(10) Pub. No.: US 2015/0290558 A1
(43) Pub. Date: Oct. 15, 2015

(54) DISTILLATION OF SILANE MIXTURES IN THE PRESENCE OF A NITRILE OR AMINE

(71) Applicant: WACKER CHEMIE AG, Munich (DE)

(72) Inventors: Javad MOHSSENI, Leipzig (DE); Andreas BOCKHOLT, Muenchen (DE); Klaus KAEPPLER, Burghausen (DE); Christian KALTENMARKNER, Burghausen (DE); Konrad MAUTNER, Burghausen (DE); Peter NUERNBERG, Nuenchritz/OT Leckwitz (DE)

(21) Appl. No.: 14/667,817

(22) Filed: Mar. 25, 2015

(30) Foreign Application Priority Data
Apr. 9, 2014 (DE) 10 2014 206 874.6

(51) Int. Cl. B01D 3/40

(52) U.S. Cl. CPC B01D 3/40

(57) ABSTRACT

Distillation of silane mixtures in the presence of a nitrile, amine, or mixtures thereof, the nitrile and amine each having a boiling point of at least 120° C. at 1013 hPa, is effective to remove metal halide, organometal halides, and other contaminants.

### CROSS-REFERENCE TO RELATED APPLICATIONS

This application claims priority to German Patent Application No. 10 2014 206 874.6 filed Apr. 9, 2014 which is herein incorporated by reference.

### BACKGROUND OF THE INVENTION

1. Field of the Invention

The invention relates to a process for the distillation of silane mixtures in the presence of a nitrile or amine.

2. Background Art

Crude silane mixtures such as the mixtures containing methylchlorosilanes and chlorosilanes from the direct synthesis (Müller-Rochow synthesis) or the chlorosilane mixtures from the hydrochlorination of metallurgical silicon can contain metal halides, organometal halides and silanes, in particular AlCl₃. The silanes in the crude silanes are separated into pure silanes by means of distillation in a plurality of stages. The impurities mentioned, in particular AlCl₃ in the ppm range, are still found in the distillates, especially in relatively high-boiling fractions. The removal of AlCl₃ by distillation is quite complicated.

Acetonitrile has been described as solvent for aluminum chloride [Zeitschrift für anorganische and allgemeine Chemie. Weinheim: Wiley-VCH, ISSN 0372-7874 vol. 511 (4. 1984), p. 148]. Acetonitrile must not be introduced into silane mixtures for the distillation since the boiling point is very close to that of chlorosilanes or methylchlorosilanes and would then itself lead to contamination.

### SUMMARY OF THE INVENTION

The invention provides a process for the distillation of silane mixtures in the presence of a nitrile or amine or mixtures thereof having a boiling point of at least 120° C. at 1013 hPa.

### DETAILED DESCRIPTION OF THE PREFERRED EMBODIMENT(S)

Metal chlorides and organometal halides, in particular AlCl₃, can be complexed by addition of relatively high-boiling nitriles and/or amines, e.g. adipodinitrile to metal chlorides or organometal halides or mixtures of metal halides and organometal halides, in particular AlCl₃-containing silane fractions from chlorosilane or methylchlorosilane distillations. This reduces the vapor pressure of the metal chlorides and organometal halides, in particular AlCl₃. A better separation of the metal chlorides and organometal halides is achieved, which in turn leads to higher yield of silanes and less waste. The tendency to fouling by metal chlorides and organometal halides in pipes and vessels is also significantly reduced by the continuous addition of relatively high-boiling nitriles and/or amines, e.g. adiponitrile.

The metal chlorides are in particular metal chlorides which can be hydrolyzed to acids by means of water. Examples are chlorides of iron, e.g. FeCl₂, FeCl₃, cobalt, nickel, chromium, titanium, tin, copper, zinc, and in particular, AlCl₃.

As nitriles, preference is given to using the nitriles of monocarboxylic acids which preferably contain from 5 to 20 carbon atoms, in particular from 6 to 12 carbon atoms. Preference is likewise given to using the nitriles of polycarboxylic acids which preferably contain from 3 to 20 carbon atoms, in particular from 4 to 10 carbon atoms. The nitriles of aliphatic, saturated monocarboxylic acids such as valeric and caproic acid and the fatty acids having up to 18 carbon atoms are preferred. The dinitriles of aliphatic, saturated dicarboxylic acids such as maleic, succinic, glutaric, adipic, pimelic and suberic acid are also preferred. Preference is given to nitriles having a boiling point of at least 150° C. at 1013 hPa, in particular at least 200° C. at 1013 hPa. Particular preference is given to adiponitrile, which boils at 295° C. at 1013 hPa, and owing to its two nitrile groups in the molecule displays a strong complexing effect on metal ions. Adiponitrile is an important intermediate for the preparation of polyamides and is therefore readily and inexpensively available.

Preference is given to adding 50-1000 parts by weight, and in particular from 100 to 300 parts by weight, of nitrile per 100 parts by weight of metal chlorides to the silane mixtures to be distilled. The process is preferably carried out at a pressure of from 500 hPa to 2000 hPa, in particular from 900 hPa to 1200 hPa.

The amines are preferably selected from among primary, secondary and tertiary aliphatic and aromatic amines. It is possible to use monoamines and also polyamines, which can have primary, secondary and tertiary amine functions.

Preferred monoamines have the general formula (I)

NR¹R²R³ (I),

where
R¹ R², R³ are each H or a monovalent hydrocarbon radical which has 1-30 carbon atoms and may be substituted by substituents selected from among F—, Cl—, OH— and OR⁴ and in which nonadjacent —CH₂— units can be replaced by units selected from among —C(═O)— and —O—, and
R⁴ is an alkyl radical having 1-10 carbon atoms, with the proviso that the monoamines have a boiling point of at least 120° C. at 1013 hPa.

The monovalent hydrocarbon radicals R¹, R², R³ can be linear, cyclic, branched, aromatic, saturated or unsaturated. Preference is given to tertiary amines, i.e. R¹, R² and R³ are monovalent hydrocarbon radicals.

The hydrocarbon radicals R¹, R², R³ preferably have from 1 to 20 carbon atoms. Particular preference is given to alkyl radicals having from 1 to 6 carbon atoms, alkylaryl radicals, arylalkyl radicals and phenyl radicals. The monovalent hydrocarbon radicals R¹, R², R³ preferably together have at least 6 carbon atoms, in particular at least 10 carbon atoms.

Preferred polyamines have the general formula (II)

R⁵₂N—(CR⁶₂)ₓ—(NR⁷—(CR⁶₂)_{y})_{z}—NR⁵₂ (II),

where
R⁵, R⁶, R⁷ are each H or hydrocarbon radicals which have 1-18 carbon atoms and may be substituted by substituents selected from among F—, Cl— and OH— and in which nonadjacent —CH₂— units can be replaced by units selected from among —C(═O)— and —O—,
x, y are integers from 1 to 6 and
z is 0 or an integer from 1 to 40, with the proviso that the polyamines have a boiling point of at least 120° C. at 1013 hPa.
x, y are preferably 2 or 3.
z is preferably an integer from 1 to 6.

Preference is given to x and y being identical.

Preferably, the monovalent hydrocarbon radicals R⁵, R⁶, R⁷ preferably together have at least 4 carbon atoms, in particular at least 6 carbon atoms.

Examples of particularly preferred polyamines (A) of the general formula (II) are:
diethylenetriamine (H₂N—CH₂CH₂—NH—CH₂CH₂—NH₂),
triethylenetetramine (H₂N—CH₂CH₂—(NH—CH₂CH₂—)₂—NH₂),
tetraethylenepentamine (H₂N—CH₂CH₂—(NH—CH₂CH₂—)₃—NH₂),
pentaethylenehexamine (H₂N—CH₂CH₂—(NH—CH₂CH₂—)₄—NH₂),
hexaethyleneheptamine (H₂N—CH₂CH₂—(NH—CH₂CH₂—)₅—NH₂), and
   mixtures of the abovementioned amines as are commercially available as industrial products, e.g. AMIX1000® (BASF SE).

Examples of further preferred monoamines and polyamines are octylamine, nonylamine, decylamine, undecylamine, dodecylamine (laurylamine), tridecylamine, tridecylamine (isomer mixture), tetradecylamine (myristylamine), pentadecylamine, hexadecylamine (cetylamine), heptadecylamine, octadecylamine (stearylamine), 4-hexylaniline, 4-heptylaniline, 4-octylaniline, 2,6-diisopropylaniline, 4-ethoxyaniline, N-methylaniline, N-ethylaniline, N-propylaniline, N-butylaniline, N-pentylaniline, N-hexylaniline, N-octylaniline, N-cyclohexylaniline, dicyclohexylamine, p-toluidine, indoline, 2-phenylethylamine, 1-phenylethylamine, N-methyldecylamine, benzylamine, N,N-dimethylbenzylamine, 1-methylimidazole, 2-ethylhexylamine, dibutylamine, dihexylamine, di-(2-ethylhexylamine), 3,3′ -dimethyl-4,4′ -diaminodicyclohexylmethane, 4,4′-diaminodicyclohexylmethane, ditridecylamine (isomer mixture), isophoronediamine, N,N,N′,N′-tetramethyl-1,6-hexanediamine, N,N-dimethylcyclohexylamine, octamethylenediamine, 2,6-xylidine, 4,7,10-trioxatridecan-1,13-diamine, 4,9-dioxadodecane-1,12-diamine, di-(2-methoxyethyl)amine, bis(2-dimethylaminoethyl)ether, polyetheramine D230® (BASF SE), 2-(diisopropylamino)ethylamine, pentamethyldiethylenetriamine, N-(3-aminopropyl)imidazole, 1,2-dimethylimidazole, bis(2-morpholinoethyl) ether, dimethylaminoethoxyethanol, bis(2-dimethylaminoethyl) ether, Lupragen®N600—S-triazine (BASF AG), 1,8-diazabicyclo-5,4,0-undec-7-ene (DBU), 3-(2-aminoethylamino)propylamine, 3-(cyclohexylamino)propylamine, dipropylenetriamine, N4-amine (N,N′-bis(3-aminopropyl)ethylenediamine), AMIX M (BASF AG) (=high-boiling morpholine derivates), 1-(2-hydroxyethyl)piperazine, 2-(2-aminoethoxy)ethanol, 3-amino-1-propanol, 3-dimethylaminopropan-1-ol, 4-(2-hydroxyethyl)morpholine, butyldiethanolamine, N-butylethanolamine, N,N-dibutylethanolamine, N,N-diethylethanolamine, dimethylaminoethoxyethanol (Lupragen®N107, BASF AG), methyldiethanolamine, diethanolamine, triethanolamine, diisopropanolamine, triisopropanolamine, 1-vinylimidazole, 1-hexylimidazole, 1-octylmidazole, 1-(2-ethylhexyl)imidazole, and triisooctylamine.

Preference is given to amines having a boiling point of at least 150° C. at 1013 hPa, in particular at least 200° C. at 1013 hPa.

In a preferred embodiment, the silane mixtures contain silanes of the general formula (1)

RₐH_{b}SiCl_{4-a-b} (1),

where
R is an alkyl radical having from 1 to 6 carbon atoms,
a is 0, 1, 2, 3 or 4 and
b is 0, 1 or 2.

R is preferably a methyl radical. In a preferred embodiment, a is 1, 2 or 3, and b is preferably 0 or 1. In another preferred embodiment, a is 0, and b is preferably 1 or 2.

The metal chlorides and organometal halides in the crude silane mixtures are preferably separated from the silanes by distillation. In the distillation, silanes are distilled off and the metal chlorides and organometal halides remain in the bottom and are, for example, disposed of, e.g. by incineration.

In a further preferred embodiment, the distilled silane mixtures contain disilanes having substituents selected from among chlorine and methyl.

The distillation of disilanes from high boiling silane mixtures requires temperatures and pressures at which many metal chlorides and organometal halides, in particular AlCl₃, develop an appreciable vapor pressure. The metal chlorides and organometal halides are distilled off in the distillate unless nitriles are added. Disilanes can be cleaved to form monosilanes by reaction with HCl in the presence of amine catalyst (e.g. tributylamine). Metal chlorides and organometal halides in disilanes lead to deactivation of the catalyst.

For the distillation of silane mixtures containing disilanes, preference is given to using nitriles having a boiling point of at least 200° C. at 1013 hPa.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A process for the purification of a crude silane mixture, comprising distilling the silane mixture in the presence of a nitrile, amine, or mixture thereof, wherein the nitrile and the amine each have a having a boiling point of at least 120° C. at 1013 hPa.

2. The process of claim 1, wherein metal chlorides or organometal halides or mixtures of metal halides and organometal halides are separated.

3. The process of claim 2, wherein at least one metal chloride or organometal halide is selected from the group consisting of chlorides of iron, cobalt, nickel, chromium, titanium, tin, copper, and zinc, and AlCl₃.

4. The process of claim 1, wherein the nitriles comprise nitriles of monocarboxylic acids containing from 5 to 20 carbon atoms and/or nitriles of polycarboxylic acids containing from 3 to 20 carbon atoms.

5. The process of claim 1, wherein adipodinitrile is used as a nitrile.

6. The process of claim 1, wherein 50-1000 parts by weight of nitrile per 100 parts by weight of metal chlorides are added to the silane mixtures to be distilled.

7. The process of claim 2, wherein 50-1000 parts by weight of nitrile per 100 parts by weight of metal chlorides are added to the silane mixtures to be distilled.

8. The process of claim 1, wherein the crude silane mixture comprises silanes of the formula (1)
RₐH_{b}SiCl_{4-a-b} (1),
where
R is an alkyl radical having from 1 to 6 carbon atoms,
a is 0, 1, 2, 3 or 4 and
b is 0, 1 or 2.

9. The process of claim 2, wherein the crude silane mixture comprises silanes of the formula (1)
RₐH_{b}SiCl_{4-a-b} (1),
where
R is an alkyl radical having from 1 to 6 carbon atoms,
a is 0, 1, 2, 3 or 4 and
b is 0, 1 or 2.

10. The process of claim 1, wherein the crude silane mixture comprises disilanes having substituents selected from the group consisting of chlorine, methyl, and mixtures thereof.

11. The process of claim 2, wherein the crude silane mixture comprises disilanes having substituents selected from the group consisting of chlorine, methyl, and mixtures thereof.

12. The process of claim 10, wherein the nitriles, amines or mixtures thereof contain nitriles and/or amines each having a boiling point of at least 200° C. at 1013 hPa.
